(19) United States
(12) Patent Application Publication
(10) Pub. No.: US 2008/0179309 A1
(43) Pub. Date: Jul. 31, 2008

(54) Soldering Iron with Direct Current Powered Heating Element

(76) Inventors: Robert T. Markovsky, Raleigh, NC (US); Claude W. Powers, Benson, NC (US); Allen D. Edwards, Apex, NC (US)

Correspondence Address: COATS & BENNETT, PLLC, 1400 Crescent Green, Suite 300, Cary, NC, 27518, US

(21) Appl. No.: 11/627,179

(22) Filed: Jan. 25, 2007

(51) Int. Cl. H05B 1/00

(52) U.S. Cl. 219/229

(57) ABSTRACT

A soldering iron includes a handle body having a gripping section for gripping by a user during operation of the soldering iron; an electrical cord supplying power to the handle body; a soldering tip assembly supported by the handle body and having a mounting end disposed proximal the handle body and a tip end disposed distal from the handle body. The soldering tip assembly includes a heating element embedded therein and disposed closer to the tip end than the mounting end, with the heating element electrically insulated from an exterior surface of the tip end. A power supply is operative to supply a controlled low voltage DC power to the heating element by converting an incoming AC power. The soldering tip assembly may be formed as a cartridge removably mated to the handle body and the soldering tip may be quick heating.

### BACKGROUND

The present invention relates to hand-held soldering irons, and more particularly to hand-held soldering irons powered by direct current.

Soldering irons are used for a variety of purposes, but are typically used to melt solder so as to solder or de-solder components to a circuit board. Typically, soldering irons are powered by electricity. The majority of soldering irons are powered by conventional AC power from an electrical wall outlet. Typically, the heating elements in such soldering iron are provided with AC power, either at line voltage or at a stepped-down AC voltage, and the soldering tips are therefore typically able to heat up more quickly and better able to maintain the desired high temperature. However, soldering irons that provide AC power to the soldering iron body, and particularly the heating element, tend to be rather bulky. As such, some soldering irons use heating elements that are DC powered, such as from internal batteries, which allows the heating elements to be more appropriately sized. However, soldering irons with DC powered heating elements typically use the exterior of the soldering tip as a return route for the DC power flowing through the heating element and also use voltages that exceed 5-7 volts. Such an arrangement runs the risk of inadvertently causing damage to more sensitive electronic components during the soldering process.

Thus, while numerous soldering iron designs have been proposed that use DC powered heating elements, they have not proven to be entirely satisfactory in some situations. Accordingly, there remains a need for alternative approaches to soldering irons with DC powered heating element(s).

### SUMMARY

In one illustrative embodiment, a soldering iron comprises an handle body having a gripping section for gripping by a user during operation of the soldering iron; an electrical step-down transformer disposed remote from the handle body and operative to convert relatively higher voltage alternating current to low voltage direct current for supply to the handle body; an electrical cord operatively connecting the transformer to the handle body; a soldering tip assembly supported by the handle body; the soldering tip having a mounting end disposed proximal the handle body and a tip end disposed distal from the handle body, the soldering tip assembly further comprising a heating element embedded therein and disposed closer to the tip end than the mounting end; the heating element electrically insulated from an exterior surface of the tip end. The soldering tip assembly may be formed as a cartridge removably mated to the handle body. The soldering tip assembly may comprise a rearward extending shroud that overlies a portion of the male plug; with an annular open space defined between the male plug and the shroud. The handle body may comprise a jack for receiving the plug, with a portion of the jack disposed in the open space when the plug is fully inserted in the jack. The electrical cord may connect to the handle body via a swiveling strain relief, with the strain relief comprising a generally spherically shaped section disposed internal to the handle body and mating with complementary recess in the handle body. The soldering iron may be adapted to heat the exterior surface of the tip end, from room temperature, to a temperature of at least 700° F. in a time period of approximately a minute and half or less, and advantageously reaches a solder melt temperature in not more than thirty seconds.

In another embodiment, a soldering iron comprises a handle body having a gripping section for gripping by a user during operation of the soldering iron; an electrical cord supplying power to the handle body; a soldering tip assembly supported by the handle body and having a mounting end disposed proximal the handle body and a tip end disposed distal from the handle body; the soldering tip assembly further comprising a heating element embedded therein and disposed closer to the tip end than the mounting end; the heating element electrically insulated from an exterior surface of the tip end; a power supply operative to supply a controlled low voltage DC power to the heating element by converting an incoming AC power.

Other aspects of various embodiments of the inventive apparatus and related methods are also disclosed in the following description. The various aspects may be used alone or in any combination, as is desired.

### BRIEF DESCRIPTION OF THE DRAWINGS

FIG. 1 shows a perspective view of a soldering iron of one embodiment in the “on” state with a support stand in the retracted position.

FIG. 2 shows a side view of the soldering iron of FIG. 1 in the “off” state with the support stand in the deployed position and a storage compartment opened.

FIG. 3 shows longitudinal cross-section of the soldering iron of FIG. 2 with the storage compartment closed.

FIG. 4 shows a perspective view of a swiveling strain relief.

FIG. 5 shows a side view of a soldering tip assembly.

FIG. 6 shows a longitudinal cross-section of the soldering tip assembly of FIG. 5.

FIG. 7 shows a side view of the soldering tip assembly to housing body connection for the embodiment of FIG. 1, partially cut-away to show the male/female electrical connection.

FIG. 8 shows another embodiment of a soldering iron with a distributed power supply.

### DETAILED DESCRIPTION

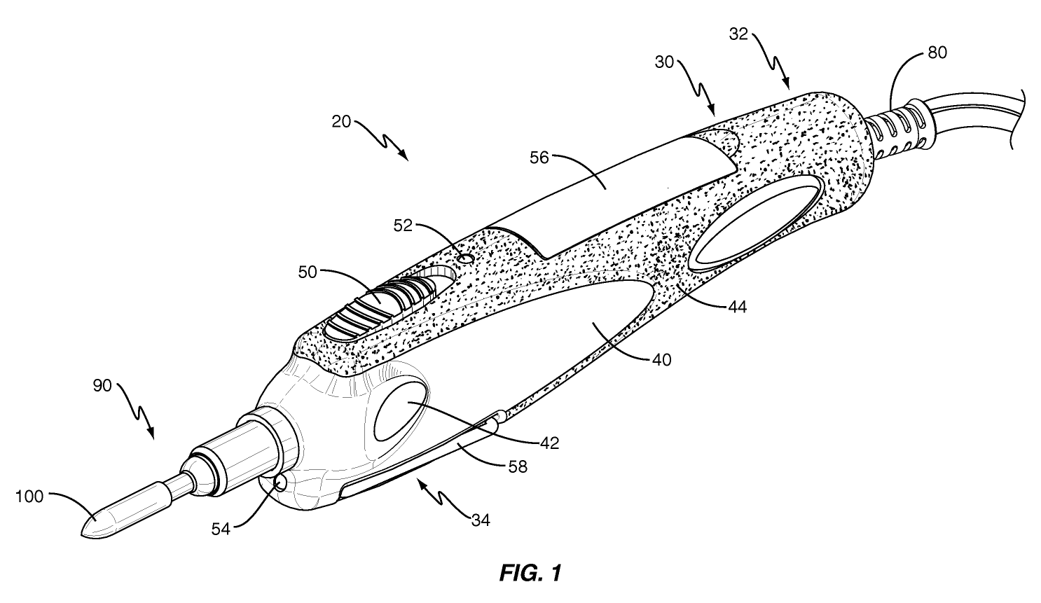

A soldering iron according to one embodiment of the present invention is shown in FIG. 1, and generally indicated at 20. The soldering iron 20 may be used to melt solder so as to solder or unsolder items in a conventional fashion. For example, the soldering iron 20 may be used to solder components, such as integrated circuit chips, resistors, capacitors, and the like, to a work area on a printed circuit board. Of course, the use of the soldering iron 20 is not limited to this example, and the soldering iron 20 may be used for a variety of other tasks.

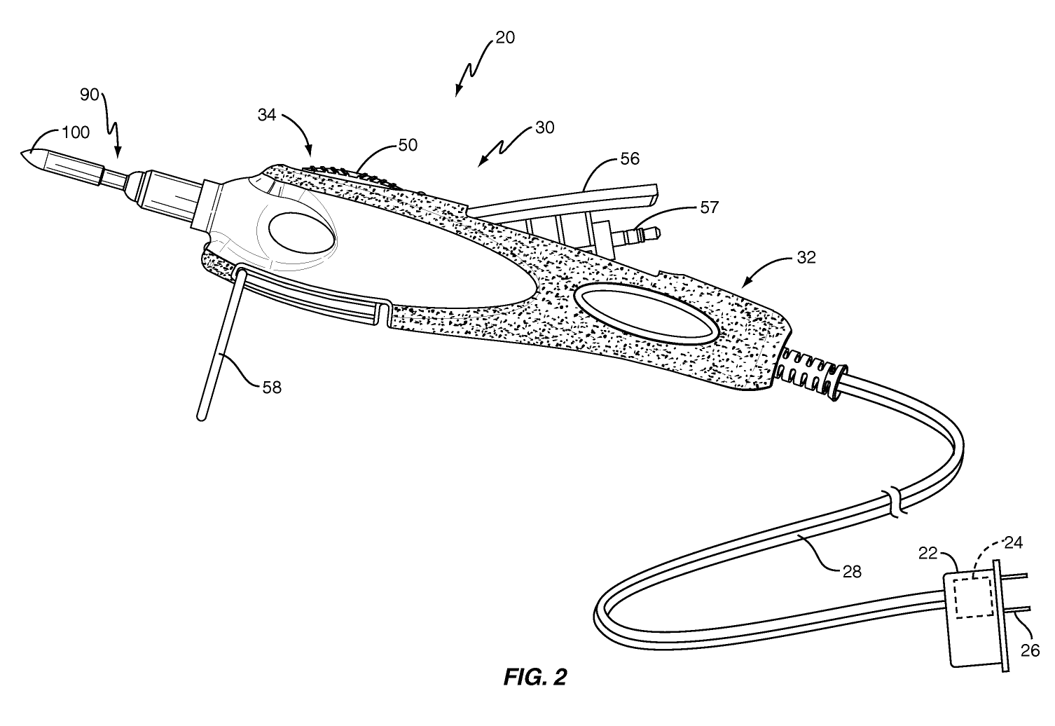

The soldering iron 20 of FIGS. 1-2 includes a power supply 22, a cord 28, a handle body 30, and a soldering tip assembly 90. The power supply 22 includes suitable electronics 24 for converting an input of alternating current to an output of low voltage direct current. These electronics 24 may be of a switching type or a non-switching type, as is desired, and are advantageously capable of converting a variety of input AC voltages and frequencies to a low voltage output. Low voltage, as used herein, means a voltage of not more than fifteen volts, and advantageously about nine volts or less. In addition, the power supply 22 advantageously outputs a controlled (or “regulated”) voltage DC, which is defined herein to mean constant within about ±5%. The power supply 22 advantageously includes suitable prongs 26 for mating with a conventional electrical wall socket. The power supply 22 of FIGS. 1-2 is disposed remote from the handle body 30, and physically and electrically connected thereto by cord 28.

The cord 28 may be of any suitable type known in the art. The cord 28 may be a two conductor cord if the handle body 30 is not connected to ground, or may be a three conductor cord if the handle body 30 is to be connected to ground. Further, when cord 28 is carrying low voltage direct current, the electrical requirements placed on the cord 28 are advantageously lessened with respect to a cord required to carry alternating current at line voltage.

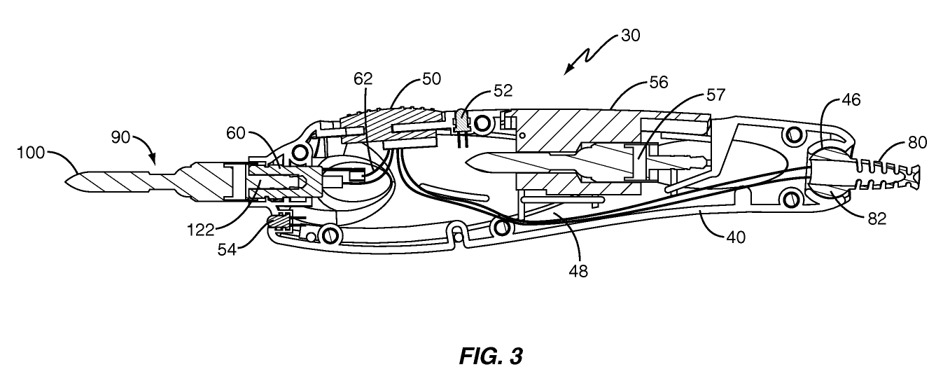

The handle body 30 extends from a rear or proximal end portion 32 nearer to where cord 28 joins handle body 30 to a forward or distal end portion 34 nearer to the soldering tip assembly 90. The handle body 30 may be generally L-shaped (sometimes referred to as pistol/gun shaped), or, as shown in FIG. 1, may be a generally straight elongate body, or any other appropriate shape. The handle body 30 of FIG. 1 includes a shell 40, an on/off switch 50, and a forward tip jack 60. The shell 40 forms the structural frame for the handle body 30, and is typically formed in two halves. The exterior of the shell 40 may advantageously include suitable laterally protruding bumps 42 on each side that act as finger rests. While the majority of the shell 40 is advantageously formed of a suitably hard and temperature resistant plastic material, such as suitable polycarbonate or a modified polyphenylene oxide (e.g., sold under the tradename Noryl®), portions of the exterior of the shell 40 may be covered in an softer elastomeric material 44, such as a thermoplastic elastomer (e.g., sold under the tradename Santoprene®). Referring to FIG. 3, the interior of shell 40 advantageously includes suitable ribbing and the like for structural strength and for providing appropriate support structures for mounting various other components. For example, the ribbing may help define a recess 46 in the rear portion of shell 40 for receiving a strain relief 80 (discussed below). In addition, these ribs may help define a cord trough 48 for guiding the portion of the cord 28 internal to shell 40. The on/off switch 50 is mounted in an upper portion of shell 40, and operates to selectively allow or interrupt the flow of DC power from cord 28 to the soldering tip assembly 90. An indicator lamp 52, such as an LED, may be connected to the on/off switch 50 to alert the user when the soldering tip assembly 90 is energized. This indicator lamp 52 may advantageously be positioned rearward of on/off switch 50. In addition, a work lamp LED 54 may be connected to the on/off switch 50 and be disposed so as to illuminate the work area of the soldering iron 20 when the soldering tip assembly 90 is energized. The tip jack 60 is disposed in the distal end portion 34 of handle body 30, and is oriented to face forward so as to be able to mate with the soldering tip assembly 90. The tip jack 60 may take a variety of forms, but typically takes the form of a female electrical connector with a central receptacle having various contact zones, such as commonly found in audio (stereo) connectors. Once again, because the tip jack 60 is intended to carry low voltage DC, the tip jack 60 need not be designed more robust so as to be able to carry AC power at line voltage. Suitable leads 62 connect tip jack 60 to on/off switch 50.

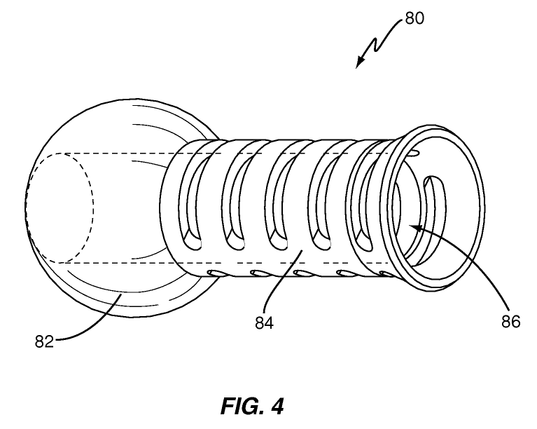

The handle body 30 may also include a strain relief 80 for helping to protect the connection between the cord 28 and the handle body 30. One example of a strain relief 80 is shown in FIG. 4. The strain relief 80 may include a forward generally spherical section 82 and a rearward tubular section 84, with a passage 86 extending through both sections. The cord 28 passes through the strain relief 80 in passage 86, and is advantageously knotted proximate thereto on the inside of shell 40, before continuing through cord trough 48 on its way to on/off switch 50. The generally spherical section 82 rests in recess 46, which is shaped in a complementary fashion, so as to allow the strain relief 80 to swivel relative to shell 40. Advantageously, the strain relief 80 is allowed to swivel to a variety of positions relative to handle body 30 in a polyaxial fashion. Thus, the strain relief 80 can assume a variety of angles, along a variety of planes, typically within a cone, relative to the handle body 30. The strain relief 80 therefore allows cord 28 to enter shell 40 in a protected fashion that allows for non-translational polyaxial movement between handle body 30 and cord 28.

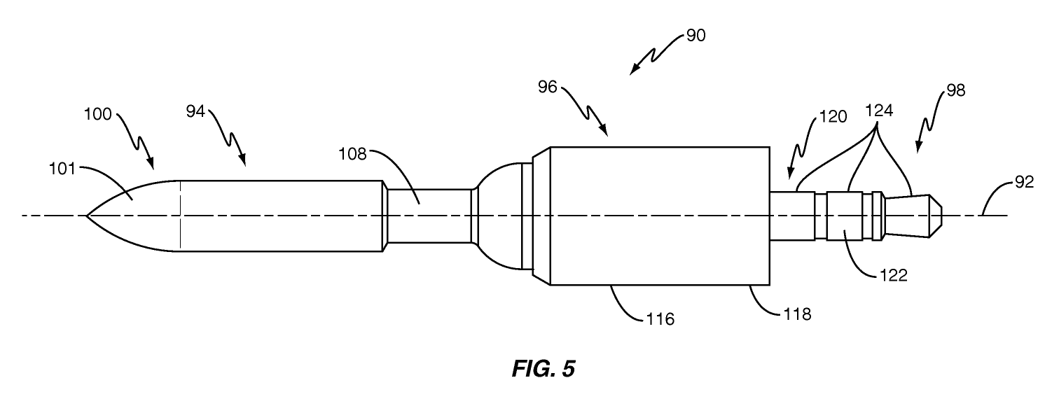

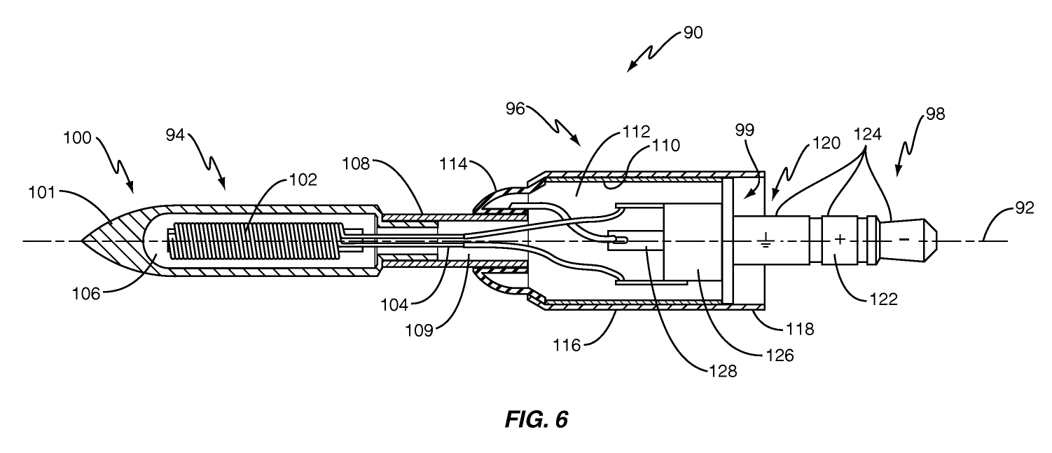

The soldering tip assembly 90 is removably mounted to the proximal end portion 32 of handle body 30; more particularly, the soldering tip assembly 90 is mated to tip jack 60. Referring to FIGS. 5-6, the soldering tip assembly 90 may be conceptually divided into a distal tip portion 94, an intermediate portion 96, and a proximal mounting portion 98. The distal tip portion 94 is a forwardly extending portion that extends along the longitudinal axis 92 of soldering tip assembly 90, and generally has a rod-like appearance. The distal tip portion 94 includes the soldering tip 100, a heating element 102, insulation 106, and a hollow barrel 108. The soldering tip 100 has a generally conically shaped configuration, as is conventional in the art. The exterior 101 of soldering tip 100 may be plated with iron, nickel, and chromium, in order to improve its soldering action. The heating element 102 is embedded in the distal tip end portion 94, and located proximate the soldering tip 100. Indeed, the heating element 102 is advantageously disposed so as to underlie a substantial portion of soldering tip 100. The heating element 102 typically takes the form of a small size resistance coil, but other forms of heating elements, such as ceramic blocks, heating rods, and the like may alternatively be used. The heating element 102 is electrically connected to handle body 30 via appropriate lead wires 104 that extend to the intermediate section 96. The heating element 102 is circumferentially surrounded by insulation 106 so as to electrically isolate the heating element 102 from the exterior 101 of soldering tip 100. The insulation 106 may be single layer or multiple layers. For example, the insulation 106 may be fiberglass material encased in a ceramic material, if desired. The barrel 108 mechanically connects the soldering tip 100 to the intermediate section 96, and provides mechanical support therefore. Advantageously, the barrel 108 is hollow so as to provide a passage 109 for the heating element's lead wires 104 to reach the intermediate section 96.

In one illustrative embodiment, the soldering tip 100 may comprise approximately 2.1 grams of copper, and the heating element 102 may take the form of heating coil. The heating coil may comprise thirty-four gage wire of 80/20 nickel/chromium (e.g., Tophet A®), with a nominal resistance of 16.25 Ohms/ft. The wire may be insulated with fiberglass to an overall diameter of 0.012 inches. The insulated wire may be wound on a 0.033 inch arbor with no spacing between coils to form a finished wound element of approximately ⅝ inch in length, with an overall resistance of approximately six Ohms. The coil may be electrically insulated from the soldering tip by using suitable material, such as a zircon based cement sold under the tradename SAUEREISEN ELECTOTEMP CEMENT #8, available from Sauereisen Cements Co. of Pittsburgh, Pa.

The intermediate section 96 includes a frame 110, a barrel flange 114, and a cover 116. The frame 110 provides the basic structural support for the intermediate section 96. The frame 110 may be generally semi-cylindrical, with a chamber 112 formed thereby. The chamber 112 provides a location for housing the base portion 126 of plug assembly 120 (discussed below), with the connection tabs 128 properly protected and electrically isolated. The barrel flange 114 is connected to the forward portion of frame 110, and annularly surrounds the rear portion of barrel 108. The cover 116 may advantageously be generally tubular, with an inner diameter slightly larger than the frame 110 and barrel flange 114. The cover 116 fits over the barrel flange 114 and the frame 110 so as to generally surround chamber 112. The rear portion of cover 116 forms an annular shroud 118 that extends rearward from frame 110.

The proximal mounting portion 98 extends rearward from the intermediate section 96 and includes plug assembly 120 and annular shroud 118. Plug assembly 120 mates with tip jack 60 to electrically connect the soldering tip assembly 90 to tip jack 60. Referring to FIG. 6, plug assembly 120 may include a plug shaft 122 and a base portion 126. The plug shaft 122 extends rearward from base portion 126 and acts as the male portion of the male/female connection with female jack 60 of handle body 30. The plug shaft 122 may be longitudinally divided into different contact regions 124 that are electrically isolated from each other in a fashion well known in the field of electrical connectors such as audio stereo jacks. For example, the rearmost region 124 may be for negative polarity, the middle region 124 for positive polarity, and the forwardmost region 124 for ground. A portion of the plug shaft 122 closest to base portion 126 is longitudinally overlaid by shroud 118 of cover 116 so that an annular open space 99 is defined therebetween. The base portion 126 of plug assembly 120 includes appropriate features for mounting to frame and includes a plurality of connection tabs 128 that are electrically connected to respective ones of the contact regions 124 on plug shaft 122. The connection tabs 124 provide a connection point for heating element lead wires 104 and are advantageously protected within chamber 112. The plug assembly 120 is advantageously permanently mounted to frame 110, the appropriate connections made, and cover 116 permanently secured to frame 110 (e.g., by welding) so that the resulting soldering tip assembly 90 is a substantially rigid cartridge structure.

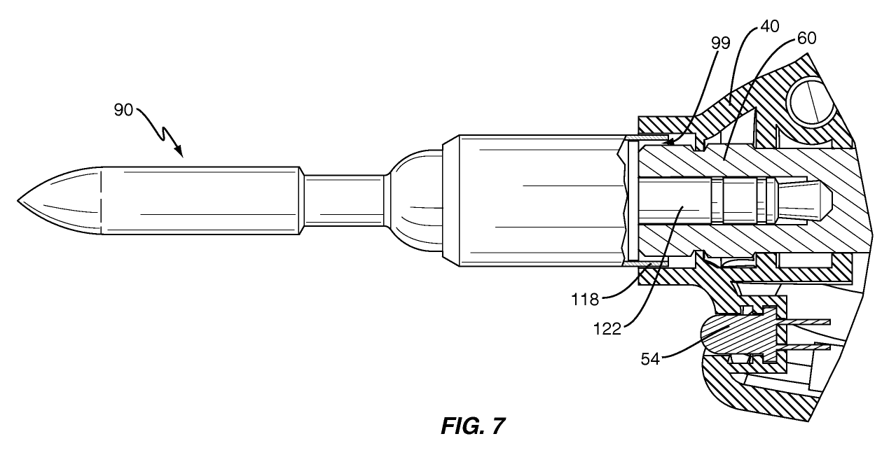

As indicated above, the soldering tip assembly 90 is removably mounted to handle body 30. When connected, plug shaft 122 extends into a corresponding hole in jack 60 so that the appropriate electrical connections are made. When plug shaft 122 is fully seated, at least a portion of jack 60 extends into open space 99 such that shroud portion 118 of cover 116 mates to, and generally surrounds this portion of jack 60. See FIG. 7. This type of overlapping connection is believed to provide greater mechanical support for soldering tip assembly 90, and thus provide a more stable soldering iron 20. When it is desired to remove soldering tip assembly 90, such as when soldering tip assembly 90 is damaged or otherwise worn out, the user simply pulls soldering tip assembly 90 longitudinally away from handle body 30 to disconnect the soldering tip assembly 90 therefrom. A suitable replacement soldering tip assembly may then be connected to handle body 30.

The soldering tip 100 of soldering iron 20 is capable of heating very quickly, despite the heating element being powered by regulated low voltage DC power. By embedding the heating element 102 in the distal end 94, proximate soldering tip 100, the generated heat need travel only a very small distance to heat soldering tip 100. Indeed, tests have shown that the soldering tip 100 may reach a temperature of 700° F. or more, from room ambient, in approximately a minute and half or less, and advantageously reaches a solder melt temperature in not more than thirty seconds. Further, the soldering iron 20 is able to provide sufficient heat energy, and recover quickly, so as to be able to complete a seven-plug soldering iron thermal capacity test common in the industry in less than seven minutes. And, because the exterior 101 of soldering tip 100 is electrically isolated from the power flowing through heating element 102, there is a greatly reduced risk of electrically damaging any components being soldered. Further still, placement of the power supply 22 remote from handle body 30 allows the handle body 30 to be relatively lightweight. And, this configuration allows the substitution of different transformers for different markets (e.g., Europe vs. United States) without having to modify the handle body 30 or soldering tip assembly 90.

In order to conveniently provide a replacement soldering tip assembly 90, it may be advantageous for handle body 30 to include a storage compartment 56 for holding an extra soldering tip assembly 57. The storage compartment 56 may be formed by a suitable storage structure along the upper portion of handle body 30 that can pivot open (FIG. 2) and closed (FIG. 1). If handle body 30 includes such an optional storage structure, suitable space should be provided between the tip of any stored soldering tip assembly 57 and cord 28, so as to prevent damage to cord 28 internal to shell 40. See FIG. 3.

Handle body 30 may also include a stand 58, if desired, for elevating the soldering tip 100 when not in use. Such as stand 58 may take the form of a simple generally U-shaped bent wire that is pivotally mounted to the underside of shell 40 in distal portion 34 of handle body 30. The stand 58 is moveable between a retracted/storage position (FIG. 1) and a deployed position (FIG. 2). With the stand 58 in the deployed position, the handle body 30 may be supported on a table or other level surface in a stable fashion with the distal end portion 34 and soldering tip assembly 90 disposed higher than the proximal end portion 32. Note that the use of a swiveling strain relief 80 facilitates this positioning by allowing the cord 28 to be conveniently routed away from the handle body 30.

In the embodiments above, it has been assumed that the soldering tip assembly 90 is in a cartridge type format that is removably mated to handle body 30; however, this is not required in all embodiments. Instead, the soldering tip assembly 90 may be of a type that is not intended to be removable by the user. For example, the soldering tip assembly 90 may be permanently attached to the handle body 30, such as by being partially embedded therein.

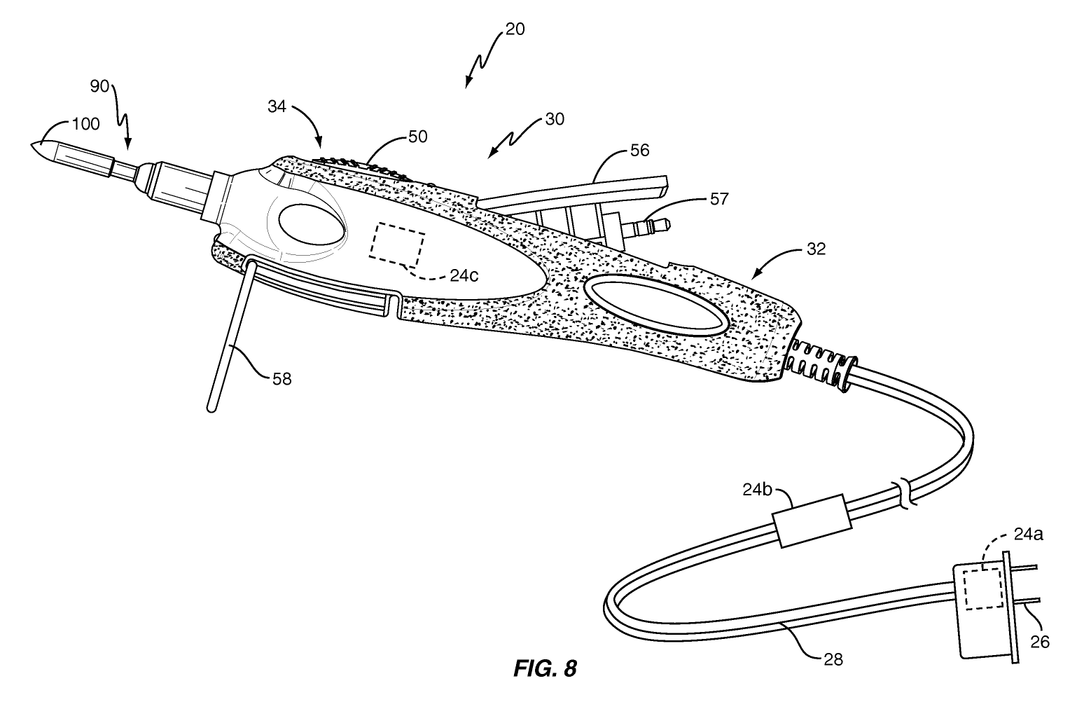

The prongs 26 of power supply 22 may be arranged in a single permanent configuration (e.g., a two or three-prong arrangement conventional in the US), or the power supply 22 may be equipped with interchangeable prongs so as to be adaptable to different outlet plug configurations (e.g., in different countries). Alternatively, the power supply 22 may be connected to an electrical outlet via a transformer cord (not shown), but such is believed less advantageous. Further, while FIGS. 1-2 show the power supply 22 contained in a single module, such is not required in all embodiments. In some embodiments, the components of electronics 24 of power supply 22 may be disposed in differing locations. For example, electronics 24 may include a step-down transformer portion 24a, an AC-to-DC conversion portion 24b, and a voltage regulation portion 24c. As shown in FIG. 8, step-down transformer portion 24a may be disposed in a housing with prongs 26, while AC-to-DC conversion portion 24b may be disposed along cord 28, and voltage regulation portion 24c may be disposed in handle body 30. Alternatively, both AC-to-DC conversion portion 24b and voltage regulation portion 24c may be disposed in handle body 30. Thus, portions of the power supply 22 may be disposed remote from the handle body 30, with other portion(s) disposed in handle body 30.

The power supply 22 advantageously supplies power to the heating element 102 at a controlled (or “regulated”) low voltage irrespective of a temperature of the soldering tip 100. The temperature of the soldering tip 100 is thus determined in an open loop fashion, without a control feedback from a thermocouple or equivalent. Instead, the voltage fed to the heating element 102 from the power supply 22 is controlled to be at a predetermined setpoint (e.g., at 9.0 volts DC), and not varied based on a sensed temperature of the soldering tip 100. In most embodiments, this setpoint cannot be varied by the user.

Further, the discussion above has assumed that the on/off state of the soldering iron 20 is controlled by an on/off switch 50; however, such is not required in all embodiments. Indeed, in some embodiments of the soldering iron 20 may not include an on/off switch 50, and the on/off state of the soldering iron 20 may be controlled by the user plugging or unplugging in the transformer 22 into an electrical outlet.

The present invention may be carried out in other specific ways than those herein set forth without departing from the scope and essential characteristics of the invention. Further, the various aspects of the disclosed device and method may be used alone or in any combination, as is desired. The disclosed embodiments are, therefore, to be considered in all respects as illustrative and not restrictive, and all changes coming within the meaning and equivalency range of the appended claims are intended to be embraced therein.

1. A soldering iron, comprising:
a handle body having a gripping section for gripping by a user during operation of the soldering iron;
a power supply disposed remote from said handle body and operative to convert relatively higher voltage alternating current to controlled low voltage direct current for supply to said handle body;
an electrical cord operatively connecting said power supply to said handle body;
a soldering tip assembly supported by said handle body; said soldering tip assembly having a mounting end disposed proximal said handle body and a tip end disposed distal from said handle body,
said soldering tip assembly further comprising a heating element embedded therein and disposed closer to said tip end than said mounting end; said heating element electrically insulated from an exterior surface of said tip end.

2. The soldering iron of claim 1 wherein said soldering tip assembly is formed as a cartridge removably mated to said handle body.

3. The soldering iron of claim 2 wherein said soldering tip assembly comprises a rearward facing male plug extending generally opposite said tip end, said male plug electrically connected to said heating element.

4. The soldering iron of claim 2 wherein said soldering tip assembly further comprises a rearward extending shroud overlying a portion of said male plug; an annular open space defined between said male plug and said shroud.

5. The soldering iron of claim 4 wherein said handle body comprises a jack for receiving said plug; a portion of said jack disposed in said open space when said plug is fully inserted in said jack.

6. (canceled)

7. The soldering iron of claim 1 wherein said exterior surface of said tip end is electrically grounded via said cord.

8. (canceled)

9. The soldering iron of claim 1 wherein said electrical cord connects to said handle body via a swiveling strain relief.

10. The soldering iron of claim 9 wherein said strain relief comprises a generally spherically shaped section disposed internal to said handle body and mating with complementary recess in said handle body.

11-12. (canceled)

13. The soldering iron of claim 1 wherein said handle body further comprises a support stand pivotally moveable between a storage position and a deployed support position.

14. The soldering iron of claim 1 wherein said heating element is adapted to heat said exterior surface of said tip end, from room temperature, to a temperature of at least 700° F. in a time period of approximately one and one-half minutes or less.

15. The soldering iron of claim 1:
wherein said soldering tip assembly is formed as a cartridge removably mated to said handle body; said soldering tip assembly comprising a rearward facing male plug extending generally opposite said tip end, said male plug electrically connected to said heating element;
said soldering tip assembly further comprising a rearward extending shroud that overlying a portion of said male plug; an annular open space defined between said male plug and said shroud; wherein said handle body comprises a jack for receiving said plug; a portion of said jack disposed in said open space when said plug is fully inserted in said jack;
wherein said heating element comprises a heating coil;
wherein said electrical cord connects to said handle body via a swiveling strain relief, said strain relief comprising a generally spherically shaped section disposed internal to said handle body and mating with a complementary recess in said handle body; and
wherein said handle body further comprises a support stand pivotally moveable between a storage position and an deployed support position.

16. The soldering iron of claim 15 further comprising a replacement soldering tip assembly and wherein said handle body further comprises a storage compartment for holding said replacement soldering tip assembly.

17. A soldering iron, comprising:
a handle body having a gripping section for gripping by a user during operation of the soldering iron;
an electrical cord supplying power to said handle body;
a soldering tip assembly supported by said handle body and having a mounting end disposed proximal said handle body and a tip end disposed distal from said handle body;
said soldering tip assembly further comprising a heating element embedded therein and disposed closer to said tip end than said mounting end; said heating element electrically insulated from an exterior surface of said tip end;
a power supply operative to supply a controlled low voltage DC power to said heating element by converting an incoming AC power.

18. The soldering iron of claim 17 wherein said power supply comprises a transformer and a voltage regulation circuit.

19. The soldering iron of claim 18 wherein said transformer and said voltage regulation circuit are both disposed remote from said handle body.

20. The soldering iron of claim 19 wherein said transformer and said voltage regulation circuit are housed together.

21. The soldering iron of claim 18 wherein said transformer is disposed remote from said handle body and said voltage regulation circuit is disposed in said handle body.

22. A method of heating a soldering iron, comprising:
providing a soldering tip assembly supported by a handle body; said soldering tip assembly having a mounting end disposed proximal said handle body and a tip end disposed distal from said handle body,
converting incoming AC power to DC power at a controlled low voltage;
supplying said DC power at said controlled low voltage to a heating element embedded in said soldering tip assembly and disposed closer to said tip end than said mounting end such that said DC power remains electrically isolated from an exterior of said soldering tip assembly.

23. The method of claim 22 wherein soldering tip assembly comprises a barrel disposed closer to said mounting end than said tip end and a soldering tip disposed in said tip end; wherein said DC power remains electrically isolated from an exterior of said soldering tip.

24. The method of claim 22 wherein said converting incoming AC power to DC power at a controlled low voltage comprises converting incoming AC power to DC power at a transformer disposed remote from said handle body and downstream from a wall outlet.

25. The method of claim 22 wherein said converting incoming AC power to DC power at a controlled low voltage comprises regulating a voltage produced by a power supply to be within about 5% of a predetermined voltage.

26. The method of claim 22 further comprising disconnecting said soldering tip assembly from said handle body.

27. The method of claim 22 wherein said supplying said DC power at said controlled low voltage to a heating element comprises manually actuating a switch associated with said handle body.

28. The method of claim 22 wherein said converting incoming AC power to DC power at a controlled low voltage comprises converting incoming AC power to DC power at said controlled low voltage irrespective of a temperature of said soldering tip assembly.

29. The method of claim 22 wherein said converting incoming AC power to DC power at a controlled low voltage comprises regulating an output voltage according to a predetermined voltage setpoint.
